(19) United States
(12) Patent Application Publication
(10) Pub. No.: US 2023/0246381 A1
(43) Pub. Date: Aug. 3, 2023

(54) MANAGEMENT SYSTEM FOR ELECTRIC VEHICLE CHARGING CABLE

(71) Applicant: Mod.al Group, Inc., American Fork, UT (US)

(72) Inventors: Erick Vega, Salt Lake City, UT (US); Preston Ruff, Draper, UT (US); Kreg Peeler, Draper, UT (US)

(21) Appl. No.: 17/587,949

(22) Filed: Jan. 28, 2022

(51) Int. Cl. H01R 13/60; B60L 53/18; B60L 53/35; B65H 75/36; B65H 51/10; B65H 57/26

(52) U.S. Cl. CPC H01R 13/60; B60L 53/18; B60L 53/35; B65H 75/364; B65H 75/368; B65H 51/10; B65H 57/26; B65H 2701/34

(57) ABSTRACT

A management system for an EV charging cable is provided. The management system can be used to manage a charging cable in a location where an EV is charged while also allowing the charging cable to be quickly and easily removed for storage or for use when charging in a different location. The management system may be configured to retract the charging cable in a controlled manner to prevent damage to the cable, the management system, or surrounding structures.

### CROSS-REFERENCE TO RELATED APPLICATIONS

N/A

### BACKGROUND

Electric vehicles (or EVs), whether cars, trucks or otherwise, must be frequently recharged. Oftentimes, an EV owner may have a 220 V outlet in his or her garage for charging an EV using an EV charging cable (or simply “charging cable”). As an example, Tesla provides a portable charging cable having a standard NEMA 14-50 plug so that a Tesla can be charged wherever a NEMA 14-50 outlet is available. Other EV manufacturers provide similar charging cables. There are also aftermarket charging cables that may be used. Accordingly, embodiments of the present invention should not be limited to any particular type of charging cable.

Maintenance of a charging cable is a difficult task. For example, many EV owners may simply drape the charging cable over some structure in their garage when they are not charging their EVs. In such cases, the charging cable creates a tripping hazard and can get easily tangled. EV owners may also store the charging cable in the trunk of the EV which again leads to tangling.

To address such issues with charging cables, many management systems have been developed. For example, some management systems employ a boom to hang the charging cable above the EV. Other management systems employ a pedestal on which the charging cable may be coiled. Further management systems may employ a wall-mounted retraction mechanism.

Although these existing management solutions provide benefits, they each have their deficiencies. For example, many management systems are highly complex and expensive making them unreasonable for many EV owners. Also, management systems that employ a retraction mechanism tend to whip the charging cable away from the EV causing damage to the wall or other structures. The retraction mechanism also typically prevents the charging cable from being removed from the management system.

### BRIEF SUMMARY

The present invention extends to a management system for an EV charging cable. The management system can be used to manage a charging cable in a location where an EV is charged while also allowing the charging cable to be quickly and easily removed for storage or for use when charging in a different location. The management system may be configured to retract the charging cable in a controlled manner to prevent damage to the cable, the management system, or surrounding structures.

In some embodiments, the present invention may be implemented as a management system for a charging cable. The management system may include a support assembly that is configured to retract a charging cable, and a storage assembly that is configured to store a portion of the charging cable while the charging cable is supported by the support assembly. The storage assembly may be separable from the support assembly to thereby store the charging cable separate from the support assembly.

In some embodiments, the support assembly may include a main pulley around which the charging cable is routed.

In some embodiments, the support assembly may include one or more additional pulleys spaced from the main pulley. The one or more additional pulleys may be configured to pivot away from the main pulley to allow the charging cable to be removed from the support assembly.

In some embodiments, the one or more additional pulleys may include an upper pulley and a lower pulley.

In some embodiments, the support assembly may include a lever that a user can manipulate to cause the one or more additional pulleys to pivot away from the main pulley.

In some embodiments, the support assembly may include a motor that controls rotation of the main pulley when the charging cable is retracted.

In some embodiments, the support assembly may include control circuitry that drives the motor to cause a connector of the charging cable to travel along an arc when the charging cable is retracted.

In some embodiments, the support assembly may include control circuitry that automatically drives the motor to cause the charging cable to be retracted.

In some embodiments, the control circuitry may automatically drive the motor in response to a signal.

In some embodiments, the storage assembly may comprise a storage container in which the portion of the charging cable is stored while the charging cable is supported by the support assembly.

In some embodiments, the storage container may include a bottom having an opening through which the charging cable extends.

In some embodiments, the storage container may include a top through which the charging cable extends.

In some embodiments, the top may be configured to close to secure the charging cable within the storage container when the storage assembly is separated from the support assembly.

In some embodiments, the present invention may be implemented as a management system for a charging cable. The management system may include a support assembly for supporting a charging cable and for controlling a retraction of the charging cable. The support assembly may include a main pulley, one or more additional pulleys positioned proximate the main pulley such that the charging cable is secured between the main pulley and each of the one or more additional pulleys, and a retraction mechanism for controlling the rotation of the main pulley to thereby control the retraction of the charging cable. The retraction mechanism may include one of a motor or a dampener assembly.

In some embodiments, the retraction mechanism may include the motor and control circuitry for driving the motor.

In some embodiments, the retraction mechanism may include the dampener assembly. The dampener assembly may include a spring and a paddle.

In some embodiments, the management system may also include a storage assembly that has a storage container through which the charging cable extends when the charging cable is supported by the support assembly. The storage assembly may be separable from the support assembly.

In some embodiments, the present invention may be implemented as a management system for a charging cable. The management system includes a mounting assembly, a support assembly coupled to the mounting assembly, and a storage assembly selectively coupled proximate to the support assembly. The support assembly is configured to selectively support a charging cable. The storage assembly is separable from the support assembly for storing the charging cable.

In some embodiments, the support assembly may include a retraction mechanism for dampening a retraction of the charging cable, and the storage assembly may include a storage container for storing the charging cable.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIGS. 1A and 1B are left and right perspective views respectively of a management system for an EV charging cable that is configured in accordance with one or more embodiments of the present invention when the management system is mounted to a wall;

FIGS. 2A and 2B are left and right perspective views respectively of a mounting assembly of the management system shown in FIGS. 1A and 1B;

FIGS. 3A and 3B are left and right perspective views respectively of support assembly of the management system shown in FIGS. 1A and 1B;

FIGS. 3C and 3D are left and right perspective views respectively of portions of the support assembly;

FIGS. 4A-4D are various views of a storage assembly of the management system shown in FIGS. 1A and 1B;

FIGS. 5A-5C illustrate how the management system shown in FIGS. 1A and 1B enables the charging cable to be removed; and

FIGS. 6A-6C illustrate a variation of the management system shown in FIGS. 1A and 1B.

### DETAILED DESCRIPTION

Embodiments of the present invention encompass a management system for an EV charging cable. The management system can support a charging cable while charging an EV and can retract and store the charging cable when not charging. The management system can also be configured to retract the charging cable in a controlled manner. The management system may also be configured to allow the charging cable to be easily removed.

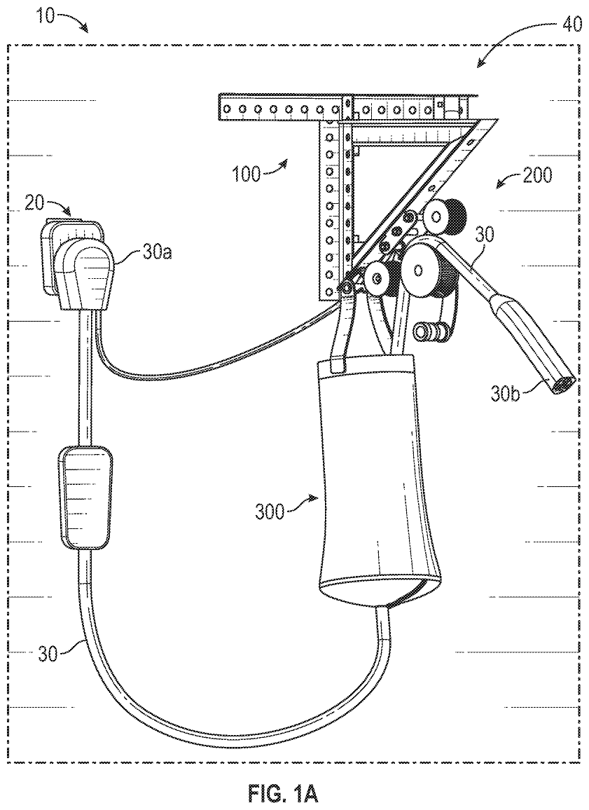

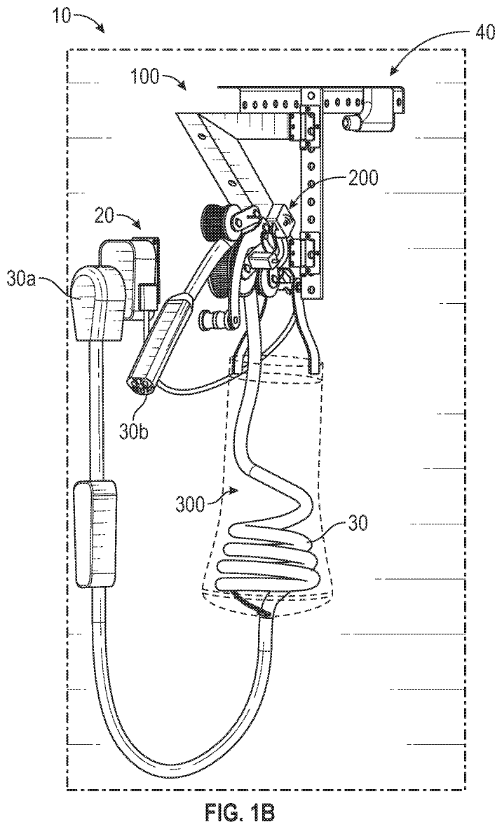

FIGS. 1A and 1B provide an example of a management system 40 that is configured in accordance with embodiments of the present invention. In this example, management system 40 is secured to a wall 10 that includes an outlet 20 and is used to manage a charging cable 30. Charging cable 30 includes a plug 30a that corresponds with outlet 20 (e.g., a NEMA 14-50 plug) and a connector 30b (e.g., the standard Tesla connector or a standard connector of another make of EV). In some embodiments, charging cable 30 could be a portable charging cable provided by the manufacturer of the EV such as a portable Tesla charging cable. However, embodiments of the present invention could be used for managing any type of charging cable.

Management system 40 generally includes a mounting assembly 100, a support assembly 200, and a storage assembly 300. Mounting assembly 100 is configured to mount support assembly 200 to a wall, ceiling, or any other suitable structure. Support assembly 200 is configured to support charging cable 30 and provide a retraction mechanism. Storage assembly 300, part of which is shown transparent in FIG. 1B, is configured to store and/or organize charging cable 30 both while charging cable 30 is supported by support assembly 200 and when charging cable 30 is removed from support assembly 200. In some embodiments, a mounting assembly may not include a storage container.

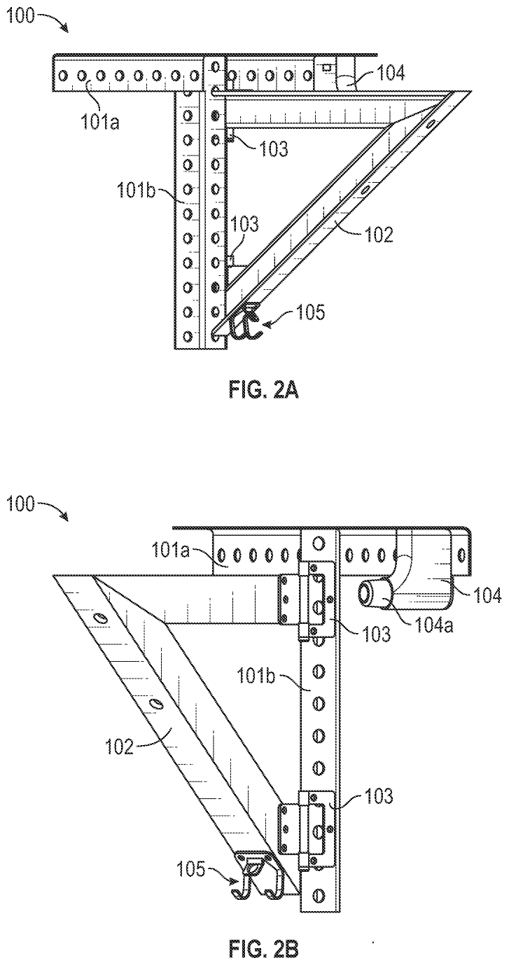

FIGS. 2A and 2B show mounting assembly 100 in isolation. Mounting assembly 100 may include any number and/or arrangement of mounting members for securing mounting assembly to wall 10 or another structure. In the depicted example, mounting assembly 100 includes a first mounting member 101a in a horizontal orientation and a second mounting member 101b that is coupled to first mounting member 101a in a vertical orientation to form a T shape. A bracket 102 may be coupled to second mounting member 101b (or any other mounting member(s) in other designs). In the depicted embodiment, bracket 102 has a triangular shape that is angled downwardly. Bracket 102 may be coupled to second mounting member 101b via hinges 103 to allow bracket 102 to pivot side-to-side. In some embodiments, mounting assembly 100 may include one or more stopping structures 104 with a stopper 104a (e.g., a cap made of rubber or other compressible material) to limit the pivoting of bracket 102. In the depicted embodiment, stopping structure 104 is secured to an end of first mounting member 101a. In some embodiments, hinges 103 may be spring hinges that bias bracket 102 against stopper 104a such as when charging cable 30 is not in use. A hook 105 may be secured to bracket 102 and may function to support storage assembly 300. Hook 105 may be positioned towards a lower end of a downward-facing surface of bracket 102.

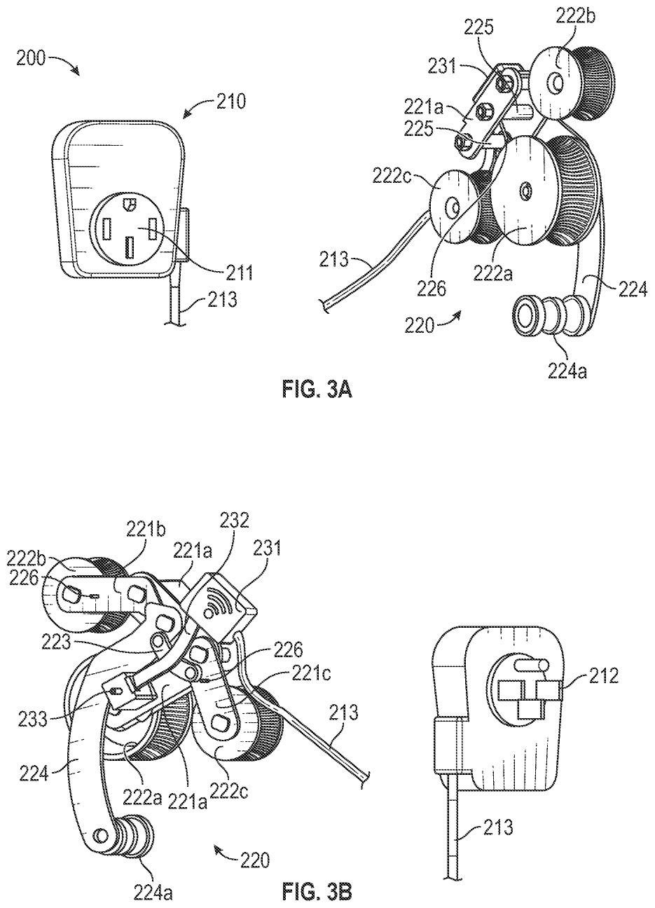

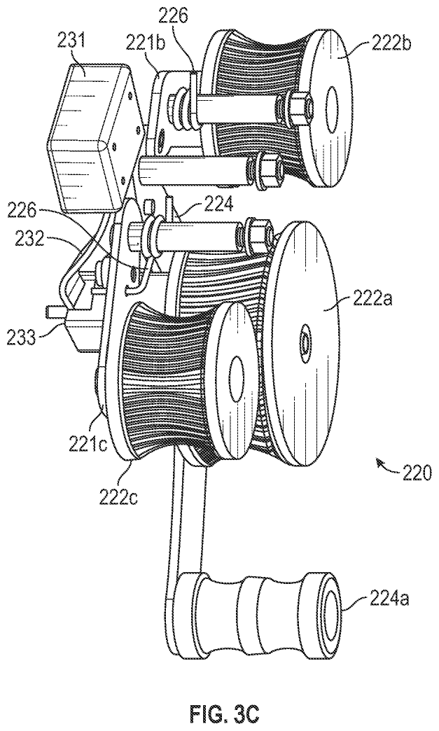

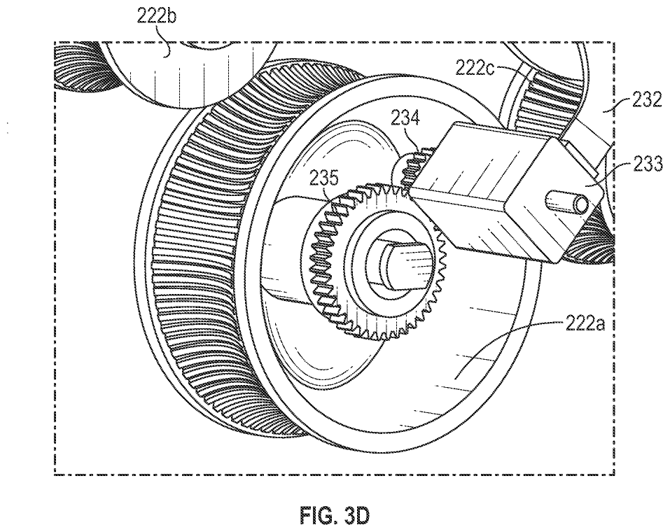

FIGS. 3A and 3B show support assembly 200 in isolation. FIGS. 3C and 3D show portions of support assembly 200 in isolation. Support assembly 200 includes a main body 221a that is configured to be secured to mounting assembly 100. For example, main body 221a can be secured to the downward-facing side of bracket 102. As labeled in FIG. 3B, main body 221a includes an arm from which a main pulley 222a is supported. An upper arm 221b may be coupled to an upper side of main body 221a, and a lower arm 221c may be coupled to a lower side of main body 221a. Upper arm 221b supports an upper pulley 222b, and lower arm 221c supports a lower pulley 222c. In this context, the terms “upper” and “lower” are intended to distinguish between the respective components and should not be construed as requiring these components to be physically upper or lower from one another.

Upper arm 221b and lower arm 221c position upper pulley 222b and lower pulley 222c in close proximity to main pulley 222a so that charging cable 30 will be secured between the pulleys when routed around main pulley 222a. In some embodiments, each pulley can be ribbed or otherwise textured to increase the amount of friction on charging cable 30.

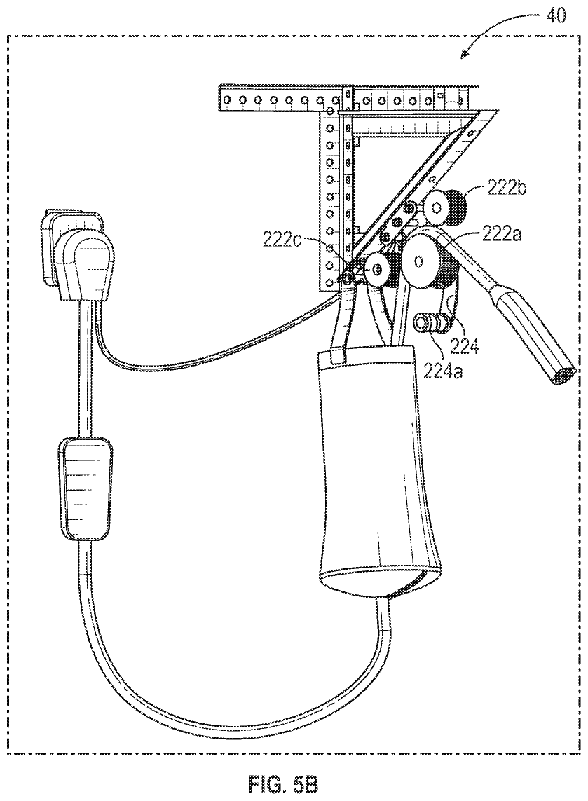

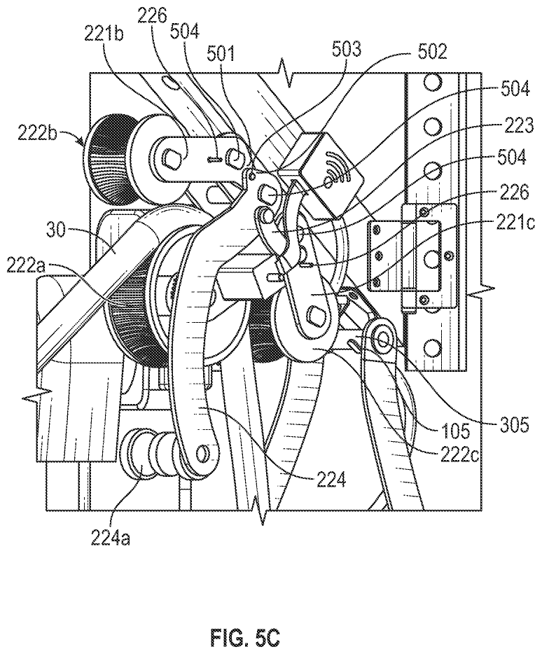

Support assembly 200 may also include a lever 224 that extends from main body 221a. Lever 224 may have a handle 224a that is positioned below (or at least beyond) main pulley 222a. Lever 224 may be configured to cause upper arm 221b and lower arm 221c to pivot to thereby move upper pulley 222b and lower pulley 222c away from main pulley 222a. In the depicted example, lever 224 couples to main body 221a between upper arm 221b and lower arm 221c. As best shown in FIG. 3C in which main body 221a is removed, springs 226 may bias upper arm 221b and lower arm 221c towards main pulley 222a. For example, springs 226 may be coiled around pins 225 that extend across main body 221a with their ends extending through upper arm 221b and lower arm 221c. The pivoting of these components is described in detail below with reference to FIG. 5C.

In the depicted embodiment, support assembly 200 includes a motor 233 for controlling the rotation of main pulley 222a. To power motor 233, support assembly 200 may include an adapter 210 having a plug 212 for connecting adapter 210 to outlet 20, a socket 211 for receiving plug 30a of charging cable 30, and a cable 213 for delivering power and possibly data. In some embodiments, support assembly 200 may include control circuitry 231 to which cable 213 is connected. In such embodiments, control circuitry 231 may be coupled to motor 233 via a cable 232.

As shown in FIG. 3D, motor 233 may drive a first gear 234 that is positioned within main pulley 222a. A second gear 235 may be formed around a shaft of main pulley 222a and may be driven by first gear 234. In this manner, motor 233 can control the rotation of main pulley 222a. As described in greater detail below, control circuitry 231 may be configured to control motor 233 while charging cable 30 is retracted.

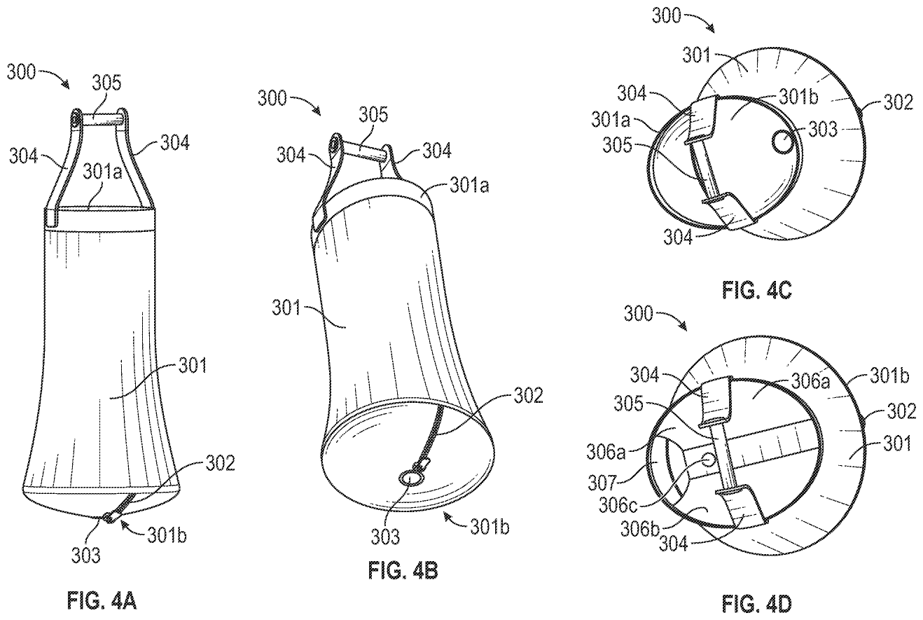

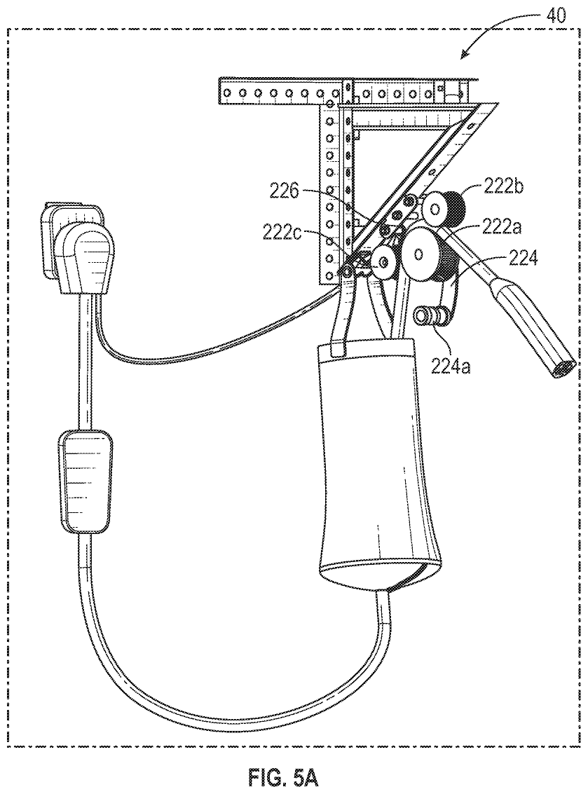

FIGS. 4A-4D show storage assembly 300 in isolation. Storage assembly 300 may include a storage container 301 having a top 301a and a bottom 301b. In some embodiments, such as the depicted embodiments, storage container 301 could be in the form of a bag. Top 301a may be open but may include flaps 306a and 306b that may be selectively closed (e.g., via a button 306c as shown in FIG. 4D) when charging cable 30 is contained in storage container 301. In some embodiments, flaps 306a and 306b may form an opening 307 through which plug 30a and or connector 30b may extend when the remainder of charging cable 30 is secured in storage container 301. Bottom 301b may include a central opening 303 having a size generally matching a diameter of charging cable 30. A zipper 302 (or other securing mechanism) may extend from the sidewall of storage container 301 to central opening 303 to facilitate removing charging cable 30 from storage container 301. Arms 304 may extend upwardly from top 301a and may support a rod 305 by which storage assembly 300 may be hung from (or otherwise selectively coupled to) hook 105. As representing in FIG. 1B, in some embodiments, the size of storage container 301 may be sufficient to allow charging cable 30 to form a coil when withdrawn into storage container 301. Also, in some embodiments, the size of storage container 301 may be sufficient to enable the entirety of charging cable 30 to be contained therein.

FIG. 5A shows management system 40 when charging cable 30 is in a retracted state. Notably, upper pulley 222b and lower pulley 222c are biased inwardly against charging cable 30 due to springs 226. In comparison, in FIG. 5B, it is assumed that a user (not shown) has pushed handle 224a towards wall 10 thereby causing upper pulley 222b and lower pulley 222c to pivot away from main pulley 222a. As a result, charging cable 30 can be withdrawn from main pulley 222a. At this point, the user could unplug plug 30a and store charging cable 30 inside storage container 301. The user could also (at any time) lift storage assembly 300 off hook 105 to store charging cable 30 in the EV or otherwise store or transport charging cable 30.

FIG. 5C better illustrates how lever 224 allows the user to remove charging cable 30 from management system 40. Lever 224 is coupled to main body 221a by, and may pivot around, a pin 504. A coupling arm 223 may couple lever 224 to lower arm 221c, while an extension 502 of lever 224 may be coupled to an extension 501 of upper arm 221b via a pin 503. These coupling points are positioned so that upper arm 221b and lower arm 221c pivot away from main pulley 222a when lever 224 is pivoted rearwardly (e.g., towards wall 10).

In some embodiments, control circuitry 231 can be configured to drive motor 233 to control the retraction of charging cable 30. For example, control circuitry 231 may include a proportional, integral, derivative (PID) controller that drives motor 233, which may be a stepper motor, to prevent the flinging of charging cable 30 when it is retracted. In such cases, the PID controller can be configured to detect when connector 30b has been disconnected from the EV's charging port (or otherwise detect when charging cable 30 should be retracted) and, in response, can incrementally increase the speed of motor 233 so that connector 30b travels along an arc as charging cable 30 is retracted. In some embodiments, control circuitry 231 may enable the user to calibrate/tune this retraction process for a particular installation of management system 40.

Control circuitry 231 may also be configured to detect when charging cable 30 has been sufficiently retracted such as by monitoring a torque on motor 233 indicative of when connector 30b is proximate to main pulley 222a. Alternatively or additionally, control circuitry 231 could be configured to track a number of rotations of motor 233 when charging cable 30 is pulled out and can then retract charging cable 30 the same number of rotations.

In some embodiments, control circuitry 231 may be configured to automatically retract charging cable 30 in response to determining that charging has been completed. For example, when an EV reaches a full charge, it may cease drawing current through charging cable 30. Because charging cable 30 is plugged in via adapter 210, adapter 210 can detect when current is cut off and can send a signal to control circuitry 231 (e.g., via cable 213 and/or wirelessly). In response, control circuitry 231 could trigger the ejection of connector 30b from the EV's charging port and could drive motor 233 to retract charging cable 30. In such embodiments, the ejection of connector 30b could be accomplished using any of the ejectors and/or techniques described in U.S. patent application Ser. Nos. 17/494,456, 17/565,096, and 17/565,107, each of which is incorporated herein by reference.

In some embodiments, control circuitry 231 may be configured to automatically retract charging cable 30 in response to user input (e.g., via a fob or mobile application). In some embodiments, control circuitry 231 may be configured to automatically retract charging cable 30 in response to a torque on motor 233. For example, after manually removing connector 30b from the EV's charging port, the user could tug on charging cable 30. In such cases, control circuitry 231 could interface with motor 233 to detect this tug and, in response, could commence retracting charging cable 30. Control circuitry 231 could use any other suitable technique to determine that charging cable 30 should be retracted.

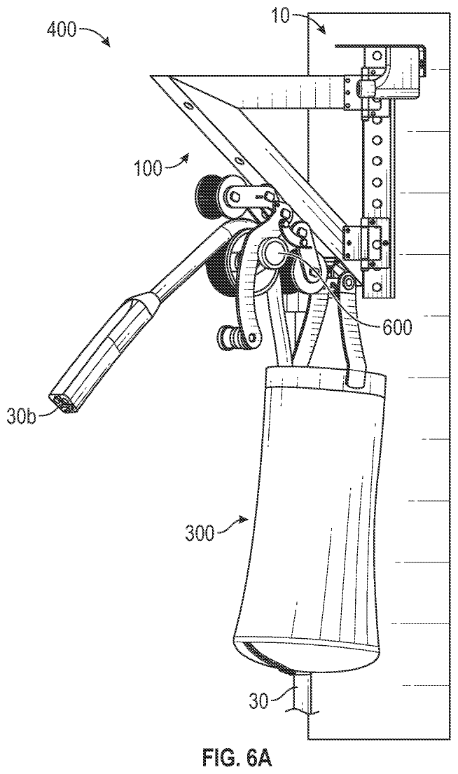

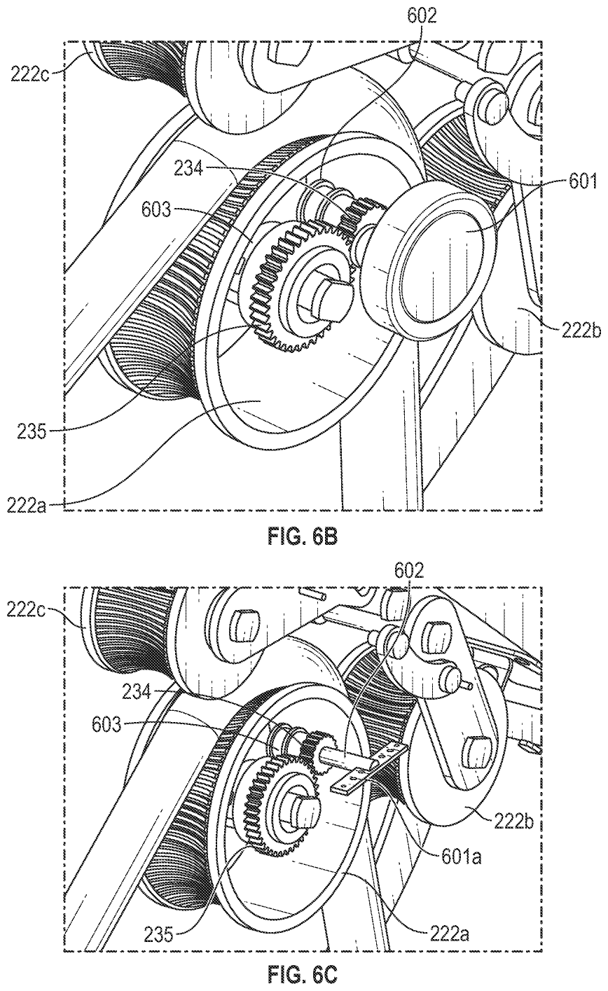

FIGS. 6A-6C provide an example where the retraction of charging cable 30 is accomplished via a dampener assembly 600 rather than via motor 233 and control circuitry 231. As best seen in FIGS. 6B and 6C in which main body 221a and lever 224 have been removed, dampener assembly 600 may include a spring 603 that is wrapped around a shaft 602 that is coupled to first gear 234. An end of spring 603 may also be fixed to a shaft of main pulley 222a. Spring 603 can function in a similar manner as a spring of a tape measure. In particular, as charging cable 30 is pulled out causing main pulley 222a to rotate, spring 603 is extended as it wraps around the shaft of main pulley 222a. Once charging cable 30 is released, spring 603 will attempt to return to its original position thus causing first gear 234 and therefore second gear 235 to rotate thereby rotating main pulley 222a to retract charging cable 30.

To control the retraction of charging cable 30, dampener assembly 600 can include an oil reservoir 601 within which a paddle 601a is disposed. Paddle 601a is connected to shaft 602 and therefore rotates as spring 603 recoils. The oil in oil reservoir 601 resists this rotation of paddle 601a thus slowing the retraction of charging cable 30 to prevent it from flinging against wall 10 or another structure.

Returning to FIGS. 1A and 1B, the position of storage assembly 300 may provide additional protection against the flinging of connector 30b during retraction. For example, if connector 30b happens to fling towards wall 10 during retraction, it may harmlessly strike storage container 301 due to its positioning below and behind main pulley 222a.

In summary, a management system configured in accordance with embodiments of the present invention allows a user to easily manage a charging cable while maintaining its portability.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A management system for a charging cable comprising:
a support assembly that is configured to retract a charging cable; and
a storage assembly that is configured to store a portion of the charging cable while the charging cable is supported by the support assembly, the storage assembly being separable from the support assembly to thereby store the charging cable separate from the support assembly.

2. The management system of claim 1, wherein the support assembly includes a main pulley around which the charging cable is routed.

3. The management system of claim 2, wherein the support assembly includes one or more additional pulleys spaced from the main pulley, the one or more additional pulleys being configured to pivot away from the main pulley to allow the charging cable to be removed from the support assembly.

4. The management system of claim 3, wherein the one or more additional pulleys include an upper pulley and a lower pulley.

5. The management system of claim 3, wherein the support assembly includes a lever that a user can manipulate to cause the one or more additional pulleys to pivot away from the main pulley.

6. The management system of claim 2, wherein the support assembly includes a motor that controls rotation of the main pulley when the charging cable is retracted.

7. The management system of claim 6, wherein the support assembly includes control circuitry that drives the motor to cause a connector of the charging cable to travel along an arc when the charging cable is retracted.

8. The management system of claim 6, wherein the support assembly includes control circuitry that automatically drives the motor to cause the charging cable to be retracted.

9. The management system of claim 8, wherein the control circuitry automatically drives the motor in response to a signal.

10. The management system of claim 1, wherein the storage assembly comprises a storage container in which the portion of the charging cable is stored while the charging cable is supported by the support assembly.

11. The management system of claim 10, wherein the storage container includes a bottom having an opening through which the charging cable extends.

12. The management system of claim 11, wherein the storage container includes a top through which the charging cable extends.

13. The management system of claim 12, wherein the top is configured to close to secure the charging cable within the storage container when the storage assembly is separated from the support assembly.

14. The management system of claim 1, further comprising:
a mounting assembly to which the support assembly is coupled.

15. A management system for a charging cable comprising:
a support assembly for supporting a charging cable and for controlling a retraction of the charging cable, the support assembly comprising:
a main pulley;
one or more additional pulleys positioned proximate the main pulley such that the charging cable is secured between the main pulley and each of the one or more additional pulleys; and
a retraction mechanism for controlling rotation of the main pulley to thereby control the retraction of the charging cable, the retraction mechanism comprising one of a motor or a dampener assembly.

16. The management system of claim 15, wherein the retraction mechanism includes the motor and control circuitry for driving the motor.

17. The management system of claim 15, wherein the retraction mechanism includes the dampener assembly, the dampener assembly including a spring and a paddle.

18. The management system of claim 15, further comprising:
a storage assembly comprising a storage container through which the charging cable extends when the charging cable is supported by the support assembly, wherein the storage assembly is separable from the support assembly.

19. A management system for a charging cable comprising:
a mounting assembly;
a support assembly coupled to the mounting assembly, the support assembly being configured to selectively support a charging cable; and
a storage assembly selectively coupled proximate to the support assembly, the storage assembly being separable from the support assembly for storing the charging cable.

20. The management system of claim 19, wherein the support assembly comprises a retraction mechanism for dampening a retraction of the charging cable, and the storage assembly comprises a storage container for storing the charging cable.
